(19) United States
(12) Patent Application Publication
(10) Pub. No.: US 2026/0159169 A1
(43) Pub. Date: Jun. 11, 2026

(54) IMPACT PROTECTION UNIT, HOUSING COMPONENT, AND MOTOR VEHICLE

(71) Applicant: ElringKlinger AG, Dettingen (DE)

(72) Inventors: Ralf FRANZ, Bad Urach (DE); Eugen KÜBLER, Owen (DE); Christian SEHL, Kirchheim unter Teck (DE); Matthias BIEGERL, Neuffen (DE); Armin EHNI, Lenningen (DE); Moritz FRANZEN, Nürtingen (DE); Julian KLEIH, Huelben (DE); Manuel NEUBAUER, Riederich (DE)

(73) Assignee: ElringKlinger AG, Dettingen (DE)

(21) Appl. No.: 19/465,207

(22) Filed: Jan. 30, 2026

Related U.S. Application Data
(63) Continuation of application No. PCT/EP2024/071922, filed on Aug. 1, 2024.

(30) Foreign Application Priority Data
Aug. 4, 2023 (DE) 10 2023 120 812.8

(51) Int. Cl. B62D 21/15; B60K 1/04

(52) U.S. Cl. CPC B62D 21/15; B60K 1/04; B60K 2001/0438; B60Y 2410/114

(57) ABSTRACT

An impact-protection unit, the impact-protection unit comprising the following: a barrier unit and a deformation unit.

### RELATED APPLICATION

This application is a continuation of international application No. PCT/EP2024/071922 filed on Aug. 1, 2024, and claims the benefit of German application No. 10 2023 120 812.8 filed on Aug. 4, 2023, which is incorporated herein by reference in their entirety and for all purposes.

### FIELD OF DISCLOSURE

The present invention relates to an impact-protection unit, a housing component, and a motor vehicle.

### BACKGROUND

The present invention is based on the object of providing as straightforwardly as possible an efficient-to-use impact-protection unit, a housing component and a motor vehicle which can be produced therewith.

### SUMMARY OF THE INVENTION

This object is achieved according to the invention by an impact-protection unit as claimed in the relevant independent claim.

The impact-protection unit comprises a barrier unit and a deformation unit.

The impact-protection unit is in particular a unit which can protect against impact.

In the context of the invention, the terms “impact”, “impacting”, etc., should be understood in particular in the broadest sense.

In particular the terms “impact”, “impacting”, etc., are not restricted to a specific impact speed. For example, an impacting object itself can be a component of the motor vehicle, the same motor vehicle also having the impact-protection unit and/or the housing component. The component can strike the impact-protection unit and/or the housing component in particular as a result of an accident and/or as a result of deformation. Impact can take place here at any speed.

The deformation unit can be in particular a deformation unit for protecting the barrier unit against an impacting object.

The deformation unit can be suitable in particular for protecting the barrier unit against an impacting object.

In the context of this description and of the attached claims, the term “in particular” is used to describe possible optional features.

If mention is made here of an impacting object, this can equally be taken to mean impact of the impact-protection unit on an object. It is conceivable for example for the object, for example a thrown-up stone, and the impact-protection unit to be moving, it being possible for the impact-protection unit to be arranged for example in the form of an underbody element on a motor vehicle.

The impact-protection unit can be a housing component, e.g. a housing component for arranging on an electrochemical energy-storage unit.

The impact-protection unit can be a cladding element for a motor vehicle, e.g. an underbody element for a motor vehicle.

It may be advantageous if the impact-protection unit has an initial-deformation zone and a secondary-deformation zone.

In the case of typical impact of an object, e.g. of a component of the same motor vehicle following an accident, due to deformation, or of a stone, deformation of the impact-protection unit in the initial-deformation zone can take place earlier than deformation in the secondary-deformation zone. The secondary-deformation zone can be located behind the initial-deformation zone, as seen in the direction of travel, and therefore the initial-deformation zone is deformed initially. The terms “initial-deformation zone” and “secondary-deformation zone” therefore merely reflect the fact that the object can advantageously come into contact first of all with the deformation zone denoted as the initial-deformation zone.

It may be advantageous if the initial-deformation zone can be deformed by a lower level of force than the secondary-deformation zone. This can apply in particular to deformation by a force which acts on the initial-deformation zone in the direction of the secondary-deformation zone and which acts in the same direction on the secondary-deformation zone.

It may be advantageous if a level of stiffness of the initial-deformation zone is lower than a level of stiffness of the secondary-deformation zone.

It may be advantageous if at least one material cross section of the impact-protection unit in the initial-deformation zone is lower than in the secondary-deformation zone.

It may be advantageous if the deformation unit comprises a force-absorbing element. The force-absorbing element can at least partially absorb a force which is active during impact. As a result, the force-absorbing element can preferably contribute to protecting the barrier unit against the impacting object.

It may be advantageous if the force-absorbing element extends from the secondary-deformation zone into the initial-deformation zone.

The force-absorbing element can extend for example in a tapering manner from the secondary-deformation zone into the initial-deformation zone. This can mean that a material cross section, a material thickness or a wall thickness of the force-absorbing element decreases from the secondary-deformation zone to the initial-deformation zone.

It may be preferred if at least one material cross section, material thickness or wall thickness of the force-absorbing element in the initial-deformation zone is lower than in the secondary-deformation zone.

The deformation unit can preferably comprise a plurality of force-absorbing elements. A plurality of the force-absorbing elements can extend from the secondary-deformation zone into the initial-deformation zone.

At least two of the force-absorbing elements can cross over one another. The force-absorbing elements can preferably be materially bonded to one another there.

It may be advantageous if the impact-protection unit has an attachment zone for attaching the impact-protection unit to a component of an apparatus. The apparatus can be for example a motor vehicle. The component can be for example a load-bearing component of the motor vehicle.

The impact-protection unit can have a shielding material which is able to shield, wholly or partially, electromagnetic waves. Such shielding materials are known to a person skilled in the art in the context of increasing the electromagnetic compatibility (EMC).

At the attachment zone, the impact-protection unit can have a contact zone, it being possible for electrical contact to be established between the shielding material and the load-bearing component of the motor vehicle via the contact zone when the impact-protection unit is being installed on the load-bearing component. The contact can be for example a direct electrical contact or an indirect electrical contact which can be established by an auxiliary element, in particular by a fastening element, e.g. a screw, a sleeve, a nut or a bolt.

It may be advantageous if the barrier unit has a barrier zone. In the barrier zone, the barrier unit can have a wall portion.

The impact-protection unit can preferably have a transition zone, which connects the barrier zone and the attachment zone. The impact-protection unit can preferably have a bend in the transition zone. The attachment zone can extend for example at an angle of approximately 45° to 100°, preferably 60° to 90°, in relation to the barrier zone.

It may be advantageous if the deformation unit extends along the attachment zone toward the barrier zone.

It may be preferred if the deformation unit extends along the attachment zone toward the barrier zone in a first deformation-unit-extent direction and if the deformation unit extends along the attachment zone parallel to the barrier zone in a second deformation-unit-extent direction.

The second deformation-unit-extent direction can preferably be oriented orthogonally in relation to the first deformation-unit-extent direction.

It may be particularly advantageous if the deformation unit extends up to the barrier zone.

It may be particularly preferred if the deformation unit merges, at the barrier zone, into the barrier unit.

It may be advantageous if a plastics material extends continuously from the barrier zone into the deformation unit. It may be particularly advantageous if a plastics material extends continuously from the barrier zone, via the deformation unit, into the attachment zone.

It may be advantageous if the force-absorbing element extends from the barrier zone along the attachment zone. It may be advantageous if the plastics material extends continuously from the barrier zone, via the force-absorbing element, into the attachment zone.

It may be advantageous if the plurality of force-absorbing elements extend from the barrier zone along the attachment zone. It may be advantageous if the plastics material extends continuously from the barrier zone, via the plurality of force-absorbing elements, into the attachment zone.

It may be advantageous if the force-absorbing element is a rib which extends from the barrier zone along the attachment zone. It may be advantageous if the rib extends continuously from the barrier zone, via the force-absorbing element, into the attachment zone. A long side of the rib can merge into the attachment zone. A short side of the rib can merge into the barrier zone.

It may be advantageous if the plurality of force-absorbing elements are ribs which extend from the barrier zone along the attachment zone. It may be advantageous if the plastics material extends continuously from the barrier zone, via the plurality of ribs, into the attachment zone. A respective long side of the ribs can merge into the attachment zone. A respective short side of the ribs can merge into the barrier zone.

The initial-deformation zone can be a first deformation zone, which is further away from the barrier zone. The secondary-deformation zone can be a second deformation zone, which is less further away from the barrier zone.

The initial-deformation zone can preferably be further away than the secondary-deformation zone from the barrier zone.

It may be preferred if the initial-deformation zone is further away than the secondary-deformation zone from the barrier zone in the first deformation-unit-extent direction.

The deformation unit can preferably extend along the attachment zone toward the barrier zone in a first deformation-unit-extent direction, wherein at least one portion of the force-absorbing element is intersected at an angle of 5° to 85°, preferably at an angle of 30° to 70°, e.g. at an angle of 35° to 65°, by a first deformation-unit-extent straight line. The first deformation-unit-extent straight line runs parallel to the first deformation-unit-extent direction.

It may be preferred if the deformation unit comprises a buffer element. The buffer element can preferably at least partially absorb a force which is active during impact. As a result, the buffer element can preferably contribute to protecting the barrier unit against the impacting object.

It may be preferred if at least one portion of the buffer element is curved. The buffer element can be a buffer element which is curved so as to run all the way round in a ring, e.g. hollow-cylindrically.

It may be preferred if the curved portion extends along a fastening zone of the impact-protection unit or extends around the fastening zone of the impact-protection unit. The impact-protection unit can be attached to a component of an apparatus via the fastening zone by means of a fastening element, e.g. a bolt. The apparatus can be for example the motor vehicle. The component can be for example the load-bearing component of the motor vehicle.

It may be advantageous if the deformation unit comprises the plurality of force-absorbing elements in addition to the buffer element and if a plurality of force-absorbing elements are connected to one another via the buffer element.

One portion of a force-absorbing element can extend for example from the buffer element in the direction of the secondary-deformation zone, preferably into the secondary-deformation zone. A further portion of the force-absorbing element can extend for example from the buffer element in the direction of the initial-deformation zone, preferably into the initial-deformation zone. At least one portion of the buffer element can form a force-absorbing-element portion which connects these two portions of the force-absorbing element. This connecting portion is preferably curved.

It may be advantageous if at least one portion of the force-absorbing element is straight. For example, that portion of the force-absorbing element which extends from the buffer element in the direction of the secondary-deformation zone can be straight. For example, that portion of the force-absorbing element which extends from the buffer element in the direction of the initial-deformation zone can be straight.

It may be advantageous if the force-absorbing element, one portion of the force-absorbing element or the two portions of the force-absorbing element is/are connected to the buffer element. The connection can be a material bond.

It may be advantageous if a plastics material, e.g. the plastics material mentioned herein, extends continuously from the buffer element into the force-absorbing element or into the portions of the force-absorbing element.

In particular, but not just by this means, surprising advantages can be achieved. For instance, firstly, a curved portion can be particularly advantageous in respect of the impact-protection unit being attached to the component of the apparatus. This applies in particular when the curved portion extends along a fastening zone of the impact-protection unit or extends around the fastening zone of the impact-protection unit. The curved portion can stabilize the fastening zone. Secondly, the curved portion can bend to a more pronounced extent in the event of an object making impact, and can thus absorb much of the kinetic energy of the object. This can considerably reduce the risk of puncturing or piercing of the deformation unit or even of the barrier zone. This can also contribute to providing as straightforwardly as possible an efficient-to-use impact-protection unit and a motor vehicle which can be produced therewith.

It may be advantageous if the deformation unit extends along the attachment zone toward the barrier zone in a first deformation-unit-extent direction and if the deformation unit extends along the attachment zone parallel to the barrier zone in a second deformation-unit-extent direction. The second deformation-unit-extent direction can preferably be oriented orthogonally in relation to the first deformation-unit-extent direction. A first extent of the deformation unit in a third deformation-unit-extent direction, oriented orthogonally in relation to the first deformation-unit-extent direction and orthogonally in relation to the second deformation-unit-extent direction, can be smaller in the initial-deformation zone than a second extent of the deformation unit in the secondary-deformation zone, the second extent being measurable in the third deformation-unit-extent direction.

The information that the deformation unit extends along the attachment zone parallel to the barrier zone in a second deformation-unit-extent direction can mean in particular that an angle which the second deformation-unit-extent direction can assume in relation to the extent direction of the barrier zone can be at most 20°, e.g. at most 10°.

It may be advantageous if the deformation unit has different thicknesses at two locations which are offset in relation to one another in the second deformation-unit-extent direction and, in the first deformation-unit-extent direction, are at equal distances from the barrier zone, e.g. from the first barrier zone, of the barrier unit. A difference in thickness can be present in a material cross section of the deformation unit at the two locations.

For example, a height of one force-absorbing element, e.g. of a rib, that is measurable in the third deformation-unit-extent direction at one of the two locations can be greater than a height of another force-absorbing element, e.g. of another rib, that is measurable in the third deformation-unit-extent direction at the other of the two locations.

For example, a thickness of one force-absorbing element, e.g. of a rib, at one of the two locations can be greater than a thickness of another force-absorbing element, e.g. of another rib, that is measurable at the other of the two locations.

It may be advantageous if the impact-protection unit contains a material which extends continuously into at least the following units, zones and/or elements: into the deformation unit and into the barrier unit and preferably into the initial-deformation zone, preferably into the secondary-deformation zone, preferably into the force-absorbing element, preferably into the attachment zone, preferably into the barrier zone, preferably into the buffer element and preferably into the fastening zone.

The material can advantageously extend continuously into at least the following units, zones and/or elements: into the deformation unit, into the barrier unit, into the initial-deformation zone, into the secondary-deformation zone, into the force-absorbing element, into the barrier zone and into the buffer element and preferably into the attachment zone, and preferably into the fastening zone.

The material can be for example a plastics material.

The plastics material contains a polymer or a mixture of different polymers. The plastics material can preferably contain one or more additives. Additives are in particular reinforcing materials, fillers, flame retardants, colorants or dyes, heat stabilizers, light stabilizers, antioxidants, stabilizers, plasticizers, propellants, lubricants, antistatic agents and impact modifiers.

It may be particularly advantageous if the plastics material contains at least one reinforcing material.

The at least one reinforcing material can comprise fibers, e.g.
glass fibers,
carbon fibers,
polymer fibers, e.g. amide fibers, in particular aramid fibers.

It may be advantageous if the fibers are dispersed in the polymer or in the mixture of different polymers.

It may be advantageous if a reinforcing element is arranged in the attachment zone and/or in the fastening zone. The reinforcing element can be embedded wholly or partially in the material. The reinforcing element can be in the form of a ring. The reinforcing element can be a metal reinforcing element, e.g. made of a steel or of an aluminum alloy.

An opening can be provided in a fastening zone. The ring-form reinforcing element can extend around the opening.

The object is achieved according to the invention by a housing component as claimed in the relevant independent claim.

The housing component can be in principle a housing component for arranging on any desired system, any desired unit, apparatus or arrangement which requires protection in the event of an impact.

The housing component can be in particular a housing component for arranging on an electrochemical energy-storage unit.

The housing component comprises an impact-protection unit and a rim structure. The impact-protection unit can be for example an impact-protection unit according to the invention described herein.

The rim structure of the housing component comprises a deformation unit or is a deformation unit. The deformation unit can be in particular the deformation unit of the impact-protection unit according to the invention described herein.

The object is achieved according to the invention by a motor vehicle as claimed in at least one of the relevant independent claims.

The motor vehicle can be in particular a wholly or partially electrically driven motor vehicle.

The motor vehicle can be a land vehicle, an aircraft or a watercraft. The motor vehicle can preferably be a land vehicle. The land vehicle can preferably be a road vehicle. The road vehicle can be for example an automobile or a truck.

A motor vehicle according to the invention described herein has an impact-protection unit described herein.

It may be preferred if the impact-protection unit forms a cladding element or part of a cladding element, e.g. an underbody element or part of an underbody element.

It may be particularly preferred if the impact-protection unit, the cladding element or the underbody element is arranged on an electrochemical energy-storage unit of the motor vehicle in such a way that at least part of the deformation unit ends up located in front of the barrier zone, as seen in the direction of travel, when the motor vehicle is traveling forward.

The electrochemical energy-storage unit can preferably be arranged in the vehicle in such a way that a front lower part of the energy-storage unit, as seen in the direction of travel, ends up located behind the barrier zone, as seen in the direction of travel, when the motor vehicle is traveling forward.

A motor vehicle according to the invention described herein has a housing component described herein.

It may be particularly preferred if the housing component is arranged on an electrochemical energy-storage unit of the motor vehicle in such a way that at least part of the deformation unit ends up located on the electrochemical energy-storage unit.

It may be particularly preferred if the housing component is arranged on an electrochemical energy-storage unit of the motor vehicle in such a way that at least part of the deformation unit ends up located in front of the electrochemical energy-storage unit, as seen in the direction of travel, when the motor vehicle is traveling forward.

It is of course possible for features described in conjunction with one entity according to the invention also to form features of another entity according to the invention described herein. Entities according to the invention here are in particular the impact-protection unit, the cladding element, the underbody element and the motor vehicle.

Further preferred features and/or advantages of the invention form the subject matter of the following description and of the illustrative drawings of exemplary embodiments.

### BRIEF DESCRIPTION OF THE DRAWINGS

FIG. 1: shows a schematic perspective illustration of a first impact-protection unit;

FIG. 2: shows a further schematic perspective illustration of the impact-protection unit shown in FIG. 1;

FIG. 3: shows a further schematic perspective illustration of the impact-protection unit shown in FIG. 1 and in FIG. 2;

FIG. 4: shows a schematic perspective illustration of a second impact-protection unit;

FIG. 5: shows a further schematic perspective illustration of the impact-protection unit shown in FIG. 4;

FIG. 6: shows a further schematic perspective illustration of the impact-protection unit shown in FIG. 4 and in FIG. 5;

FIG. 7: shows a schematic perspective illustration of a third impact-protection unit and

FIG. 8: Shows a Detail From FIG. 4.

Identical or functionally equivalent elements are denoted by the same reference signs in all the figures.

### DETAILED DESCRIPTION OF THE DRAWINGS

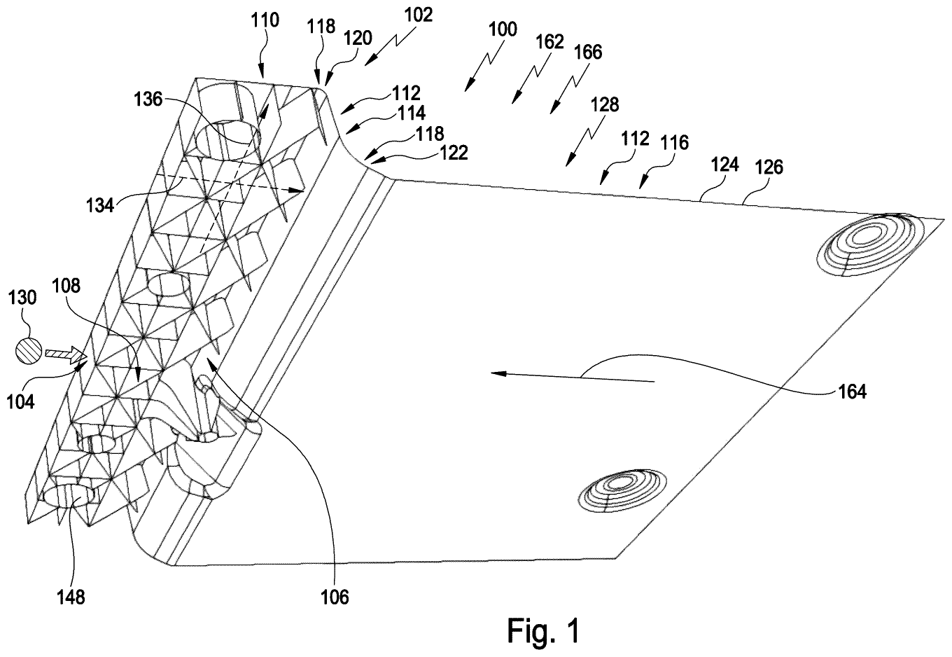

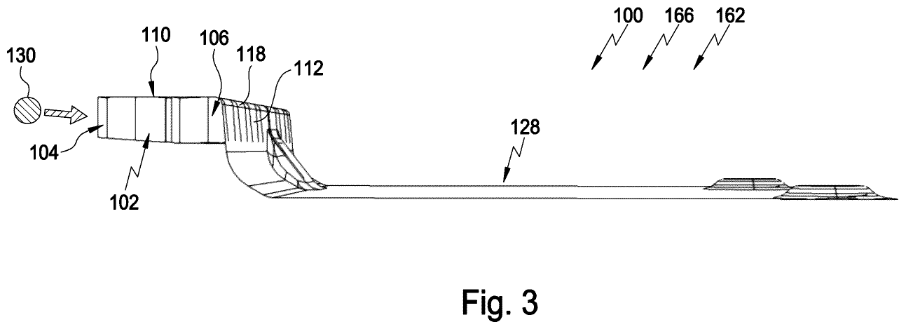

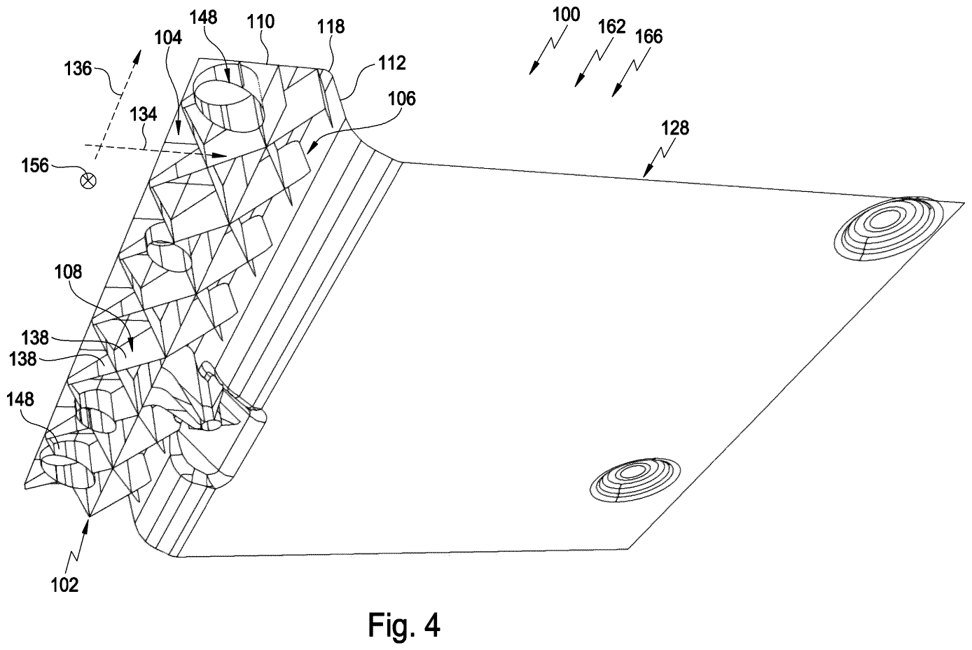

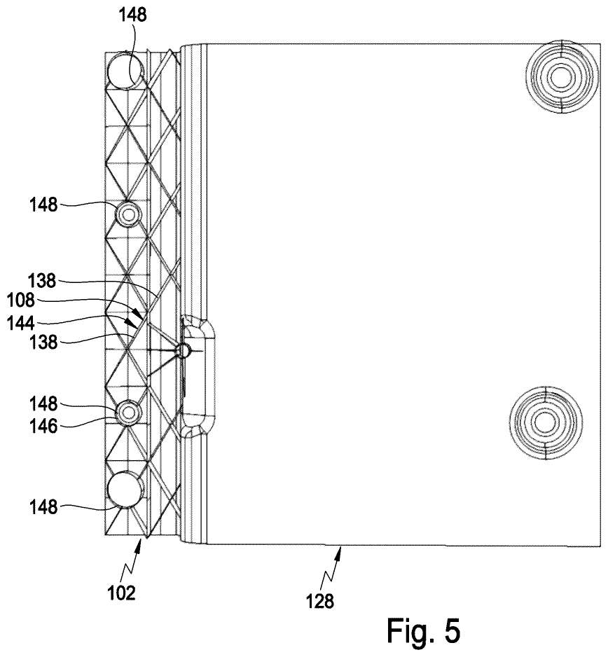

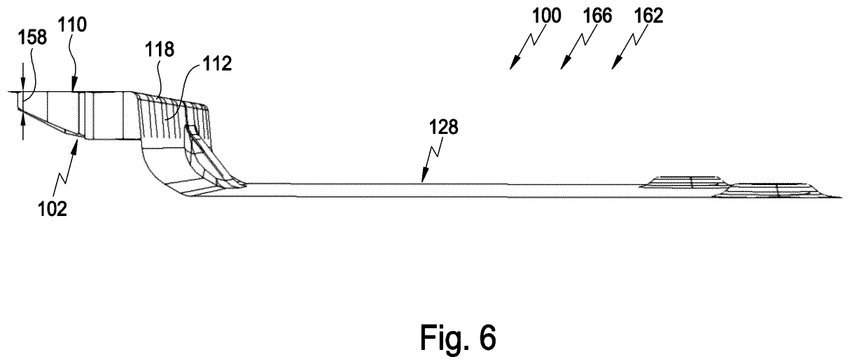

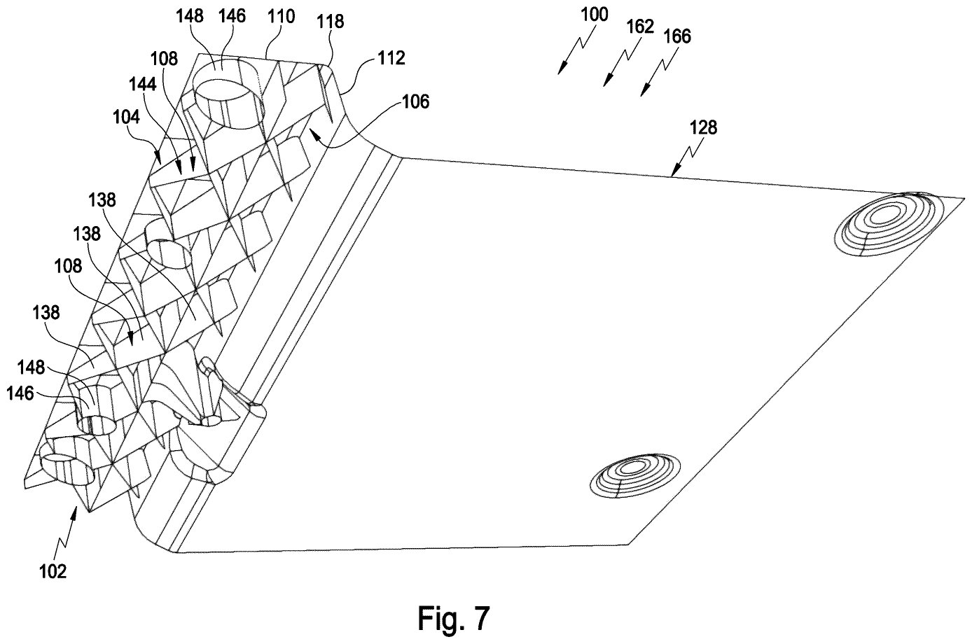

FIGS. 1 to 3 show a first embodiment of an impact-protection unit 100. FIGS. 4 to 6 show a second embodiment of an impact-protection unit 100. FIG. 7 shows a third embodiment of an impact-protection unit 100.

All the figures show schematic illustrations of the respective impact-protection unit. The illustrations are schematic inter alia insofar as wall and/or material thicknesses are each illustrated on a very small scale.

The impact-protection units 100 of the three embodiments shown each comprise a barrier unit 128 and a deformation unit 102.

The deformation unit 102 serves to protect the barrier unit 128 against an impacting object 130. This is illustrated by FIG. 1. A direction of travel 164 is indicated therein.

The impact-protection unit 100 can form for example an underbody element 162 or part of an underbody element 162 of a motor vehicle (not shown here). The impact-protection unit 100 or the underbody element 162 can be arranged for example on an electrochemical energy-storage unit of the motor vehicle in such a way that at least part of the deformation unit 102 ends up located in front of the barrier zone 112, as seen in the direction of travel 164, when the motor vehicle is traveling forward.

The object 130 can be for example a stone which is thrown up by a motor vehicle in front and impacts against the deformation unit 128.

In the case of the three impact-protection units shown in FIGS. 1 to 7, the deformation unit 102 has in each case an initial-deformation zone 104 and a secondary-deformation zone 106.

In the case of typical impact of the object 130, deformation of the impact-protection unit 100 in the initial-deformation zone 104 can take place earlier than deformation in the secondary-deformation zone 106. The secondary-deformation zone 106 is located behind the initial-deformation zone 104, as seen in the direction of travel, and therefore the initial-deformation zone 104 is deformed initially. The terms initial-deformation zone 104 and secondary-deformation zone 106 therefore merely reflect the fact that the object 130 typically comes into contact first of all with the deformation zone denoted as the initial-deformation zone 104.

In the case of all three embodiments shown, the deformation unit 102 comprises a force-absorbing element 108. The force-absorbing element 108 can at least partially absorb a force which is active during impact of the object 130. As a result, the force-absorbing element 108 contributes to protecting the barrier unit 128 against the impacting object 130. The force-absorbing elements 108 extend from the secondary-deformation zone 106 into the initial-deformation zone 104.

The embodiments shown each have an attachment zone 110 for attaching the impact-protection unit 100 to a component of an apparatus. The apparatus (not shown) can be a motor vehicle. The component can be a load-bearing component of the motor vehicle.

In the case of all three embodiments shown, the barrier unit 128 has a barrier zone 112 and a transition zone 118, which connects the barrier zone 112 and the attachment zone 110. Moreover, the deformation unit 102 extends along the attachment zone 110 toward the barrier zone 112. The barrier zone 112 can be understood to be a first barrier zone 114. The barrier unit 128 can have a second barrier zone 116 in addition.

The transition zone 118 can be understood to be a first transition zone 120. The barrier unit 128 can have a second transition zone 122, which connects the first barrier zone 114 and the second barrier zone 116.

It is clear in particular from FIG. 1 that the deformation unit 102 extends along the attachment zone 110 toward the barrier zone 112 in a first deformation-unit-extent direction 134. It is also clear from FIG. 1 that the deformation unit 102 extends along the attachment zone 110 parallel to the barrier zone 112 in a second deformation-unit-extent direction 136. This is because the two first and second deformation-unit-extent directions 134 and 136 mentioned are indicated by dashed arrows in FIG. 1.

In the case of the other two embodiments according to FIGS. 4 to 7, however, the deformation unit 102 extends in the same way along the attachment zone 110. The deformation-unit-extent directions are also indicated in FIG. 4.

The second deformation-unit-extent direction 136 is oriented in each case orthogonally in relation to the first deformation-unit-extent direction 134.

FIGS. 1 to 7 show that the deformation unit 102 extends in each case up to the barrier zone 112 and, at the barrier zone 112, merges into the barrier unit 128.

In addition, the deformation unit 102 extends toward the barrier zone 112 in each case transversely in relation to an extent direction 132 of the transition zone 118.

In the case of all three embodiments, the initial-deformation zone 104 is further away than the secondary-deformation zone 106 from the barrier zone 112. The initial-deformation zone 104 is further away than the secondary-deformation zone 106 from the barrier zone 112 in each case in the first deformation-unit-extent direction 134.

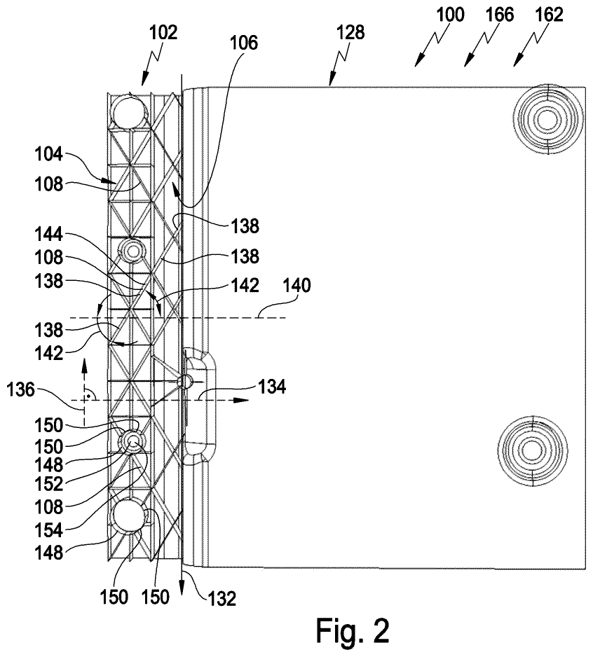

The deformation unit 102 extends along the attachment zone 110 toward the barrier zone 112 in a first deformation-unit-extent direction 134. At least one portion 138 of the force-absorbing element 108 is intersected at an angle 142 of approximately 55° by a first deformation-unit-extent straight line 140, which runs parallel to the first deformation-unit-extent direction 134. The straight line 140 and the angle are indicated for the first embodiment in FIG. 2. Similar angles can be gathered for the second and third embodiments.

The three deformation units 102 of the three embodiments each comprise a buffer element 148. The latter can also at least partially absorb a force which is active during impact. The buffer element 148 can also contribute to protecting the barrier unit 128 against the impacting object 130.

The force-absorbing element 108 can form a first force-absorbing element 144. The buffer element 148 can form a second force-absorbing element 146.

Portions 150 of the buffer elements 148 are each curved. In the case of certain buffer elements 148, curved portions 150 extend along a fastening zone 152 of the impact-protection unit 100. The impact-protection unit 100 can be attached to the component, e.g. the load-bearing member, of the apparatus, e.g. the motor vehicle, via the fastening zone 152 by means of a fastening element, e.g. a bolt. Bolts (not illustrated) can be guided through openings 154, which can be provided in the fastening zones 152.

The portions 138 of the force-absorbing elements 108 are straight, force-absorbing elements 108 being connected to buffer elements 148.

In the case of all three embodiments, the deformation unit 102 extends along the attachment zone 110 toward the barrier zone 112 in the first deformation-unit-extent direction 134. In the case of all three embodiments, the deformation unit 102 extends along the attachment zone 110 parallel to the barrier zone 112 in the aforementioned second deformation-unit-extent direction 136. Moreover, a first extent 158 of the respective deformation unit 102 in a third deformation-unit-extent direction 156 is smaller in the initial-deformation zone 104 than a second extent 160 of the deformation unit 102 in the secondary-deformation zone 106, the second extent being measurable in the third deformation-unit-extent direction 156. The third deformation-unit-extent direction 156 is oriented orthogonally in relation to the first deformation-unit-extent direction 134 and orthogonally in relation to the second deformation-unit-extent direction 136.

The impact-protection unit 100 contains a material 124. This is a plastics material 126. In the case of all three embodiments, the impact-protection unit 100 is a respective injection molding 166. The plastics material 126 extends continuously into the deformation unit 102, into the barrier unit 128, into the initial-deformation zone 104, into the secondary-deformation zone 106, into the force-absorbing element 108, into the attachment zone 110, into the barrier zone 112, into the buffer element 148 and into the fastening zone 152. Moreover, the impact-protection units 100 shown comprise a shielding material (not illustrated) which is able to shield, wholly or partially, electromagnetic waves. The shielding material can be present in particular in the barrier unit in a compound-layer arrangement with the plastics material 126.

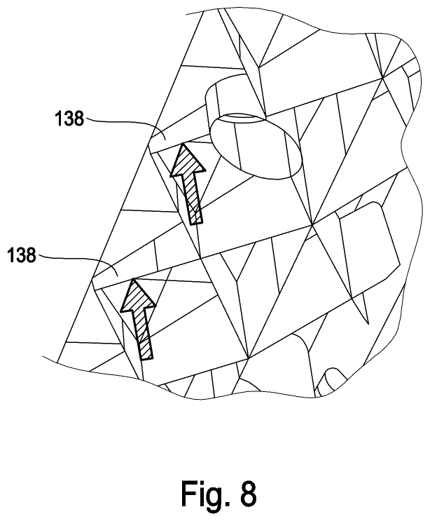

FIG. 8 shows a detail from FIG. 4. The two arrows added indicate two locations on different force-absorbing elements 108. The two locations are offset in relation to one another in the second deformation-unit-extent direction. In the first deformation-unit-extent direction, the two locations are at equal distances from the first barrier zone.

The arrows are merely intended to indicate the possibility of the two force-absorbing elements being of different thicknesses at the two locations, although this is not illustrated in FIGS. 4 and 8. For example, a height of one force-absorbing element, e.g. of a rib, that is measurable in the third deformation-unit-extent direction at the first of the two locations can be greater than a height of another force-absorbing element that is measurable in the third deformation-unit-extent direction at the second of the two locations.

This can contribute to more or less the same protection being achievable over the entire length of the deformation unit. In particular, the different thicknesses of force-absorbing elements can wholly or partially compensate for the effects of buffer elements. This can be advantageous in particular when the buffer elements are not uniformly distributed in the deformation unit.

### LIST OF REFERENCE SIGNS

100 impact-protection unit
102 deformation unit
104 initial-deformation zone
106 secondary-deformation zone
108 force-absorbing element
110 attachment zone
112 barrier zone
114 first barrier zone
116 second barrier zone
118 transition zone
120 first transition zone
122 second transition zone
124 material
126 plastics material
128 barrier unit
130 object
132 extent direction of the transition zone
134 first deformation-unit-extent direction
136 second deformation-unit-extent direction
138 portion of the force-absorbing element
140 first deformation-unit-extent straight line
142 angle
144 first force-absorbing element
146 second force-absorbing element
148 buffer element
150 portion of the buffer element
152 fastening zone
154 opening
156 third deformation-unit-extent direction
158 first extent
160 second extent
162 underbody element
164 direction of travel
166 injection molding

1. An impact-protection unit comprising:
a barrier unit; and
a deformation unit.

2. The impact-protection unit as claimed in claim 1, wherein the deformation unit has
an initial-deformation zone; and
a secondary-deformation zone.

3. The impact-protection unit as claimed in claim 1, wherein
the deformation unit comprises the following:
a force-absorbing element, which is capable of at least partially absorbing a force which is active during impact, as a result of which the force-absorbing element can contribute to protecting the barrier unit against an impacting object.

4. The impact-protection unit as claimed in claim 3, wherein
the force-absorbing element extends in a tapering manner from the secondary-deformation zone into the initial-deformation zone.

5. The impact-protection unit as claimed in claim 1, wherein
the impact-protection unit has an attachment zone for attaching the impact-protection unit to a component of an apparatus.

6. The impact-protection unit as claimed in claim 1, wherein
the barrier unit has a barrier zone, or
the barrier unit has a barrier zone, and the impact-protection unit has a transition zone, which connects the barrier zone and the attachment zone.

7. The impact-protection unit as claimed in claim 6, wherein
the deformation unit extends along the attachment zone toward the barrier zone,
or the deformation unit extends along the attachment zone toward the barrier zone in a first deformation-unit-extent direction and the deformation unit extends along the attachment zone parallel to the barrier zone in a second deformation-unit-extent direction, which is oriented orthogonally in relation to the first deformation-unit-extent direction, and/or wherein the deformation unit extends up to the barrier zone, and/or wherein the deformation unit merges, at the barrier zone, into the barrier unit.

8. The impact-protection unit as claimed in claim 6, wherein
the initial-deformation zone is further away than the secondary-deformation zone from the barrier zone, or
the initial-deformation zone is further away than the secondary-deformation zone from the barrier zone in the first deformation-unit-extent direction.

9. The impact-protection unit as claimed in claim 6, wherein
the deformation unit extends along the attachment zone toward the barrier zone in a first deformation-unit-extent direction, and
at least one portion of the force-absorbing element is intersected at an angle of 5° to 85° or at an angle of 35° to 65° by a first deformation-unit-extent straight line, which runs parallel to the first deformation-unit-extent direction.

10. The impact-protection unit as claimed in claim 1, wherein
the deformation unit comprises the following:
a buffer element, which can at least partially absorb a force which is active during impact, as a result of which at least partial absorption of the force the buffer element can contribute to protecting the barrier unit against an impacting object.

11. The impact-protection unit as claimed in claim 10, wherein
at least one portion of the buffer element is curved.

12. The impact-protection unit as claimed in claim 11, wherein the curved portion extends along a fastening zone of the impact-protection unit, and
the impact-protection unit is attachable to a component of an apparatus via the fastening zone by means of a fastening element or a bolt.

13. The impact-protection unit as claimed in claim 3, wherein
at least one portion of the force-absorbing element is straight.

14. The impact-protection unit as claimed in claim 10, wherein
the force-absorbing element is connected to the buffer element.

15. The impact-protection unit as claimed in claim 6, wherein
the deformation unit extends along the attachment zone toward the barrier zone in a first deformation-unit-extent direction and the deformation unit extends along the attachment zone parallel to the barrier zone in a second deformation-unit-extent direction, which is oriented orthogonally in relation to the first deformation-unit-extent direction, and/or
a first extent of the deformation unit in a third deformation-unit-extent direction, oriented orthogonally in relation to the first deformation-unit-extent direction and orthogonally in relation to the second deformation-unit-extent direction, is smaller in the initial-deformation zone than a second extent of the deformation unit in the secondary-deformation zone, the second extent being measurable in the third deformation-unit-extent direction.

16. The impact-protection unit as claimed in claim 1, wherein
the impact-protection unit contains a material or a plastics material, and
the material or the plastics material extends continuously into at least the following units, zones and/or elements:
into the deformation unit, and
into the barrier unit, and/or
into the initial-deformation zone, and/or
into the secondary-deformation zone, and/or
into the force-absorbing element, and/or
into the attachment zone, and/or
into the barrier zone, and/or
into the buffer element, and/or
into the fastening zone.

17. A housing component comprising:
said impact-protection unit as claimed in claim 1, and
a rim structure, wherein
the rim structure of the housing component is or comprises a deformation unit or the deformation unit of the impact-protection unit as claimed in claim 1.

18. A motor vehicle, wherein the motor vehicle having said impact-protection unit as claimed in claim 1, wherein
the impact-protection unit is an underbody element or part of an underbody element, and/or
the impact-protection unit or the underbody element is arranged on an electrochemical energy-storage unit of the motor vehicle in such a way that at least part of the deformation unit ends up located in front of the barrier zone, as seen in the direction of travel, when the motor vehicle is traveling forward.

19. A motor vehicle, wherein the motor vehicle having said housing component as claimed in claim 17, wherein
the housing component is arranged on an electrochemical energy-storage unit of the motor vehicle in such a way that at least part of the deformation unit ends up located in front of the electrochemical energy-storage unit, as seen in the direction of travel, when the motor vehicle is traveling forward.
